(19) United States
(12) Patent Application Publication
(10) Pub. No.: US 2014/0019989 A1
(43) Pub. Date: Jan. 16, 2014

(54) MULTI-CORE PROCESSOR SYSTEM AND SCHEDULING METHOD

(71) Applicant: FUJITSU LIMITED, Kawasaki-shi (JP)

(72) Inventors: Takahisa Suzuki, Kawasaki (JP); Koichiro Yamashita, Hachioji (JP); Hiromasa Yamauchi, Kawasaki (JP); Koji Kurihara, Kawasaki (JP); Toshiya Otomo, Kawasaki (JP); Naoki Odate, Akiruno (JP)

(73) Assignee: FUJITSU LIMITED, Kawasaki-shi (JP)

(21) Appl. No.: 14/026,285

(22) Filed: Sep. 13, 2013

Related U.S. Application Data
(63) Continuation of application No. PCT/JP2011/056261, filed on Mar. 16, 2011.

(51) Int. Cl. G06F 9/50

(52) U.S. Cl. CPC G06F 9/5088
USPC 718/105

(57) ABSTRACT

A multi-core processor system includes plural CPUs; memory that is shared among the CPUs; and a monitoring unit that instructs a change of assignment of threads to the CPUs based on a first process count stored in the memory and representing a count of processes under execution by the CPUs and a second process count representing a count of processes assigned to the CPUs, respectively.

### CROSS REFERENCE TO RELATED APPLICATIONS

This application is a continuation application of International Application PCT/JP2011/056261, filed on Mar. 16, 2011 and designating the U.S., the entire contents of which are incorporated herein by reference.

### FIELD

The embodiment discussed herein is related to a multi-core processor system and scheduling method that change thread assignment to processors in the multi-core processor system.

### BACKGROUND

According to a known scheduling method for a multi-core processor system, a thread is moved from a high-load node (processor) to a low-load node (see, e.g., Japanese Laid-Open Patent Publication No. H8-30472).

It is known that threads belonging to the same process often share the same data and frequently communicate with one another. Thus, communication among the processors can be reduced and a cache can efficiently be used by assigning the threads belonging to the same process to the same processor. According to another scheduling method that takes the above into consideration, when the process is started up, whether all the threads in a process to be executed are to be assigned to the same processor or to plural processors is determined based on the history of past executions (see. e.g., Japanese Laid-Open Patent Publication No. 2002-278778).

From the viewpoint of distribution of load among processors, balanced load distribution can easily be established when the threads are executed by different processors. However, with a configuration that determines whether the threads are to be assigned to the same processor when the process is started up such as that described in Japanese Laid-Open Patent Publication No. 2002-278778, the determination of is made only when the process is started up. Therefore, a problem arises in that variations in the load balance cannot be coped with when another process repeats starting up or coming to an end after the process is started up.

According to the technique described in Japanese Laid-Open Patent Publication No. H8-30472, the thread of the high-load processor is merely moved to the low-load processor and one process cannot be assigned to the same processor. The techniques described in Japanese Laid-Open Patent Publication No. 2002-278778 and H8-30472 may conceivably be combined, whereby whether one process is to be distributed to plural processors is determined taking into consideration the load balance and the assignment destinations of the threads belonging to the same process when the loads need to be distributed. However, by simply combining the techniques of Japanese Laid-Open Patent Publication No. 2002-278778 and H8-30472, the determination process steps for determining the threads to be moved when the loads are distributed increases. Therefore, a problem arises in that the overhead for the load distribution increases.

In a case where the number of processes increases, when the processes are fragmented and the threads of the same process are distributed and assigned to plural processors, the number of combinations of processors to execute the threads becomes tremendous, making it difficult to find within a limited time period, a combination such that the same process is assigned to the same processors while establishing balanced load, for each of the processes to be executed. Therefore, an approach is desired for a multi-core processor to improve the fragmentation and improve the processing efficiency for a case where numerous processes are fragmented.

### SUMMARY

According to an aspect of an embodiment, a multi-core processor system includes plural CPUs; memory that is shared among the CPUs; and a monitoring unit that instructs a change of assignment of threads to the CPUs based on a first process count stored in the memory and representing a count of processes under execution by the CPUs and a second process count representing a count of processes assigned to the CPUs, respectively.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of an example of a configuration of a multi-core processor system according to an embodiment;

FIG. 2 is a block diagram of an internal configuration of a fragmentation monitoring unit;

FIG. 3 is a flowchart of an example of an operation process of the fragmentation monitoring unit;

FIG. 4 is a flowchart of an example of a load distribution operation process executed by the OS;

FIG. 5 is a flowchart of an example of an operation process for suspension notification to a load distributing unit of an OS;

FIG. 6 is a flowchart of an example of an operation process for start-up notification to the load distributing unit of the OS;

FIG. 7 is a diagram of an example of a load distribution process executed by the load distributing unit of the OS;

FIG. 8 is a diagram of an ideal assignment state of threads;

FIG. 9 is a diagram of a state where fragmentation of processes advances;

FIG. 10 is a diagram of a state of thread transfer among the processors; and

FIG. 11 is a diagram of a state where the fragmentation of the processes is improved as a result of reassignment.

### DESCRIPTION OF EMBODIMENTS

A preferred embodiment will be described in detail with reference to the accompanying drawings.

A multi-core processor disclosed herein executes load distribution for each thread taking into consideration only the load balance. When a process is fragmented and threads belonging to the process are distributed to and executed by plural processors, load distribution is executed such that by restarting an arbitrary processor, the process assigned thereto and distributed to other processors is transferred back to the restarted processor. The processor to be restarted merely has to be configured to again accept the processing of the process after the process has been temporarily transferred to the other processors. This corresponds to temporarily discontinuing the function of the processor. Thus, the threads distributed to the plural processors due to the fragmentation of the process can be easily consolidated at one processor, fragmentation can be reduced and the load balance can be equalized among the processors by a simple process.

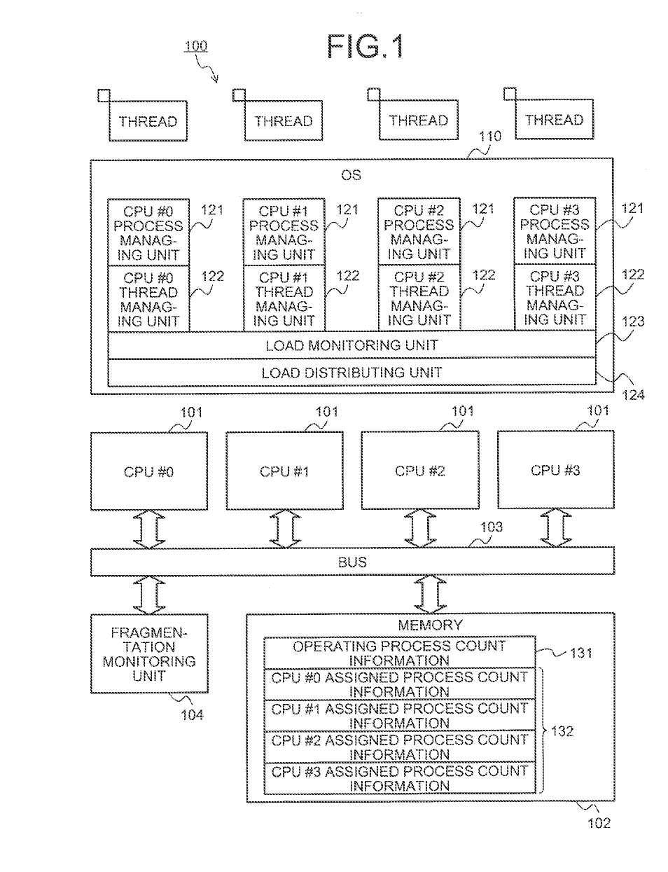

FIG. 1 is a block diagram of an example of a configuration of a multi-core processor system according to an embodiment. As depicted in FIG. 1, the multi-core processor system 100 includes a shared-memory multi-core processor system including plural processors (CPU #0 to #3) 101 and memory 102, respectively connected by a bus 103.

In the embodiment, the multi-core processor system 100 includes a fragmentation monitoring unit (monitoring unit) 104 that monitors fragmentation of a process and is connected to the bus 103. Provided that the fragmentation monitoring unit 104 has a function of monitoring the fragmentation, implementation may be by hardware including a logic circuit, etc. or software.

An operating system (OS) 110 includes a process managing unit 121 that manages for each of the processors 101, processes executed by the processor 101; a thread managing unit 122 that manages threads in the processes; a load monitoring unit 123 that consolidates and monitors the loads on the processors 101; and a load distributing unit 124 that assigns the load of a processor 101 to another processor 101.

The memory 102 has storage areas for operating process count information 131 that indicates the number of operating processes (first process count) to record the number of processors currently operating in the entire multi-core processor system 100, and for assigned process count information 132 that indicates the number of processes (second process count) assigned to the processors (CPU #0 to #3) 101.

When a process is newly started up from another process currently started up, the process currently started up requests the OS 110 to generate the process.

The OS 110 generates the process instructed by the process managing unit 121, increases the value of the operating process count information 131 of the memory 102 by one each time a process is generated and simultaneously, requests the thread managing unit 122 to generate threads of the process. When the threads are generated, the load distributing unit 124 assigns the generated threads to low-load processors based on load information concerning the processors collected by the load monitoring unit 123.

The process managing unit 121 of the OS 110 manages the number of processes assigned to each of the processors 101. The processor 101 to which a thread is newly assigned checks whether any other thread is assigned thereto that belongs to the same process as that of the thread newly assigned, using the process managing unit 121 and the thread managing unit 122 of the OS 110 that corresponds to the processor 101. If the processor 101 determines that no thread has been assigned thereto that belongs to the same process, in the memory 102, the process managing unit 121 increases the value of the assigned process count information 132 that corresponds to the processor 101 by one.

The load monitoring unit 123 of the OS 110 periodically monitors the loads on the processors 101. When the difference in the load between the highest-load processor 101 and the lowest-load processor 101 is greater than or equal to a specific value, the load distributing unit 124 transfers an arbitrary thread from the highest-load processor 101 to the lowest-load processor 101. In this case, the processor 101 from which the thread is transferred refers to the assigned process count information 132 and checks whether any thread belonging to the same process as that of the transferred thread is also assigned to another processor 101. If the processor 101 determines that no such thread is present, the processor 101 decreases in the memory 102, the value of the assigned process count information 132 that corresponds to the processor 101 by one. The other processor 101 to which the thread is transferred changes the value of the assigned process count information 132 similar to the case where a process is newly generated (increases the value by one).

When a currently operating thread newly generates another thread, the currently operating thread requests the OS 110 to generate the other thread and the thread managing unit 122 of the OS 110 generates the thread. The thread generated in this case belongs to the same process as that of the request source thread. When the thread is generated, the generated thread is assigned to the low-load processor 101 by the load distributing unit 124 similarly to the case where the process is newly generated, and this processor 101 varies (increases by one) the value of the assigned process count information 132 for this processor 101.

When a currently operating thread comes to an end, the thread managing unit 122 deletes the thread and, similarly to the case where the thread is transferred from the processor 101, decreases by one the value of the assigned process count information 132 when the corresponding processor 101 has no thread that belongs to the same process. When the entire multi-core processor system 100 has no thread that belongs to the same process, the process managing unit 121 determines that the process comes to an end, deletes the process, and decreases the value of the operating process count information 131 by one.

As the load determination method, methods are present such as, for example, a method of using the operating rate of the processors 101; a method of using a standby time period of each thread; a method of measuring in advance the processing time period for a thread and using the total of remaining processing time periods of assigned threads; and a method of determining the loads by using these indices combined with each other. However, in the embodiment, any one of the methods may be used to determine the loads.

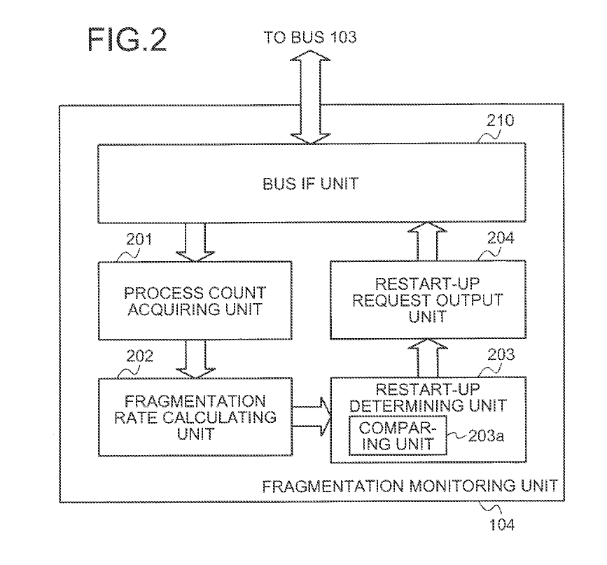

FIG. 2 is a block diagram of an internal configuration of the fragmentation monitoring unit. The fragmentation monitoring unit 104 includes a process count acquiring unit 201, a fragmentation rate calculating unit 202, a restart-up determining unit 203, a restart-up request output unit 204, and a bus IF unit 210. The bus IF unit 210 is an interface for the input and output of signals with respect to the bus 103.

The process count acquiring unit 201 acquires the operating process count information 131 and the assigned process count information 132 for each processor, that are stored in the memory 102. The fragmentation rate calculating unit 202 calculates a fragmentation rate (fragmentation coefficient) of the processes using an equation as below, based on the operating process count information 131 and the assigned process count information 132 acquired by the process count acquiring unit 201. The “operating process count” is the number of processes currently operated by all the processors, and the “total number of assigned processes” is the total number of processes assigned to the CPUs 101.

Fragmentation rate=total number of assigned processes/operating process count

The restart-up determining unit 203 includes a comparing unit 203a that compares the fragmentation rate to a predetermined threshold value. If the fragmentation rate exceeds the predetermined threshold value, the restart-up determining unit 203 determines that the fragmentation advances, refers to the assigned process count information 132, and outputs to the processor 101 (the OS 110) that has the greatest number of processes assigned thereto, a restart-up request to reassign processes. The restart-up request is output, via the restart-up request output unit 204, to the processor 101 for which the fragmentation is advanced.

The threshold value used by the restart-up determining unit 203 to determine the fragmentation is set based on any one of conditions 1 to 5 below or any combination thereof.

### 1. Number of Processors

The fragmentation tends to advance as the number of processors increases. Therefore, as to this condition, the threshold value is set to be higher as the number of processors increases.

### 2. Cache Size

The effect of the fragmentation decreases, the larger the cache size is. Therefore, as to this condition, the threshold value is set to be lower, the larger the cache size is.

### 3. Coherent Operation Time Period

The effect of the fragmentation decreases as the coherent operation time period becomes shorter. Therefore, as to this condition, the threshold value is set to be lower, the shorter the coherent operation time period is.

4. Operation Time Period (Time Period from Discontinuation to Restart-Up of Processor)

When the operation time period is long, the threshold value is set to be high and thereby, the frequency of the restarting up is reduced.

### 5. Probability of Process to be Consolidated by Disclosed Technique

When the probability of the process to be consolidated is high, the threshold value is set to be low.

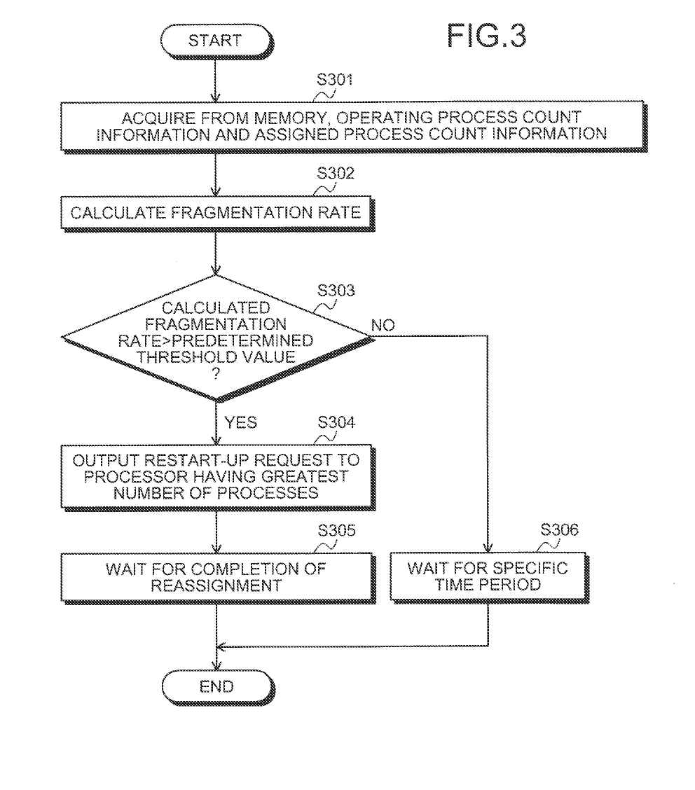

FIG. 3 is a flowchart of an example of an operation process of the fragmentation monitoring unit. In the fragmentation monitoring unit 104, the process count acquiring unit 201 periodically acquires the operating process count information 131 stored in the memory 102, and for each processor, the assigned process count information 132 (step S301). The fragmentation rate calculating unit 202 calculates the fragmentation rate based on the acquired operating process count information 131 and the acquired assigned process count information 132 (step S302).

The restart-up determining unit 203 determines whether the fragmentation rate calculated by the fragmentation rate calculating unit 202 exceeds the predetermined threshold value (step S303). If the fragmentation coefficient exceeds the predetermined threshold value (step S303: YES), the restart-up determining unit 203 determines that the fragmentation advances, outputs a restart-up request to the processor 101 (the OS 110) having the greatest number of processes assigned thereto (step S304), waits for the reassignment of the processes consequent to the restart-up of the processor 101 to come to an end (step S305), and causes the process steps to come to an end. On the other hand, if the fragmentation coefficient is smaller than the predetermined threshold value (step S303: NO), the restart-up determining unit 203 determines that no fragmentation occurs, waits for a specific time period (step S306), and after a predetermined time period elapses, periodically executes again the operations at step S301 and thereafter.

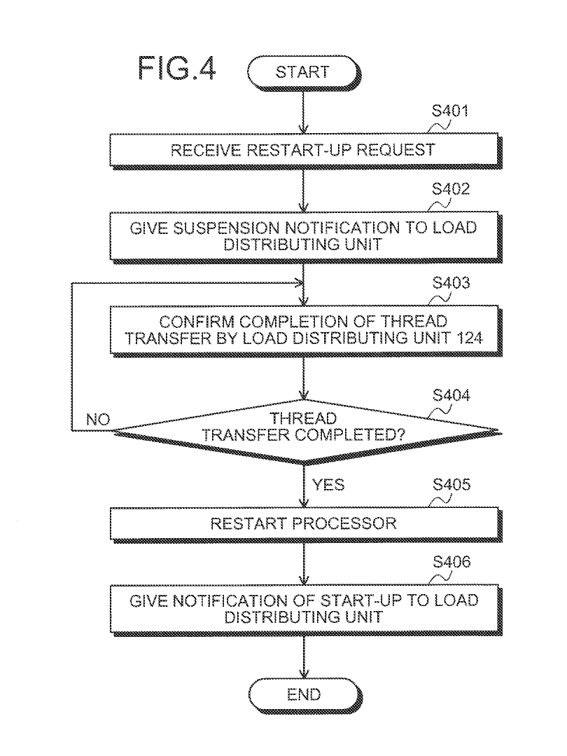

FIG. 4 is a flowchart of an example of a load distribution operation process executed by the OS. Due to the process of FIG. 3, the OS 110 receives the restart-up request for a certain processor 101 from the fragmentation monitoring unit 104 (step S401). Thereby, the OS 110 gives suspension notification to the load distributing unit 124 (step S402), confirms completion of the thread transfer by the load distributing unit 124 (step S403). If the thread transfer has not been completed, the OS 110 awaits completion (step S404: NO). If the thread transfer has been completed (step S404: YES), the OS 110 restarts the processor 101 for which the restart-up request is received (step S405), gives notification of the start-up to the load distributing unit 124 (step S406), and causes the process steps to come to an end.

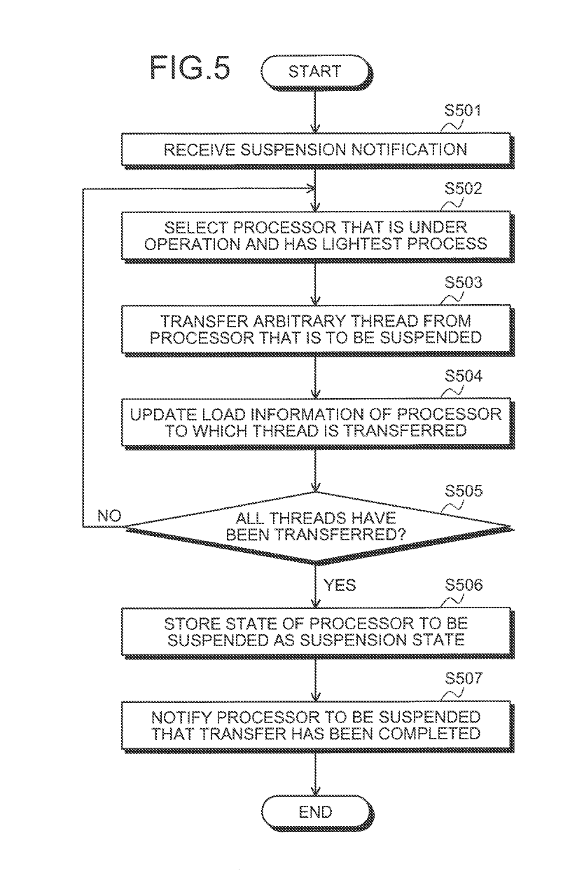

FIG. 5 is a flowchart of an example of an operation process for suspension notification to the load distributing unit of the OS. The load distributing unit 124 receives suspension notification (step S501) and selects the processor 101 that is under operation and has the lightest process (step S502), causes an arbitrary thread to be transferred to another processor 101, from the processor 101 that is to be suspended and for which the restart-up request is received (step S503), and thus, updates the load information of the processor 101 to which the thread is transferred (step S504).

The load distributing unit 124 determines whether all the threads of the processor 101 that is to be suspended have been transferred (step S505). Until the transfer of all the threads has been completed (step S505: NO), the load distributing unit 124 executes again the operations at step S502 and thereafter. When the transfer of all the threads has been completed (step S505: YES), the load distributing unit 124 stores the state of the processor 101 to be suspended as a suspension state (step S506), notifies the processor 101 to be suspended that the transfer has been completed (step S507), and causes the process steps to come to an end.

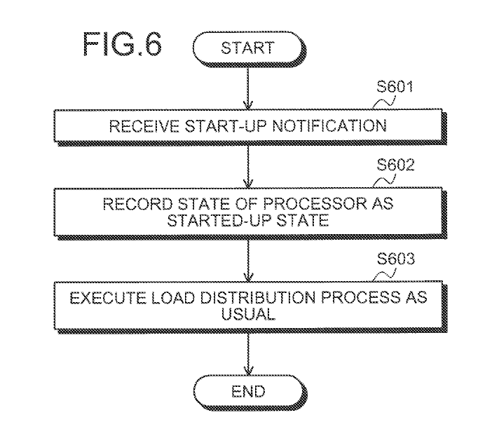

FIG. 6 is a flowchart of an example of an operation process for start-up notification to the load distributing unit of the OS. The load distributing unit 124 receives start-up notification (step S601), records the state of the processor 101 for which the start-up notification is received, as a started-up state (step S602), executes load distribution process as usual (step S603), and causes the process steps to come to an end.

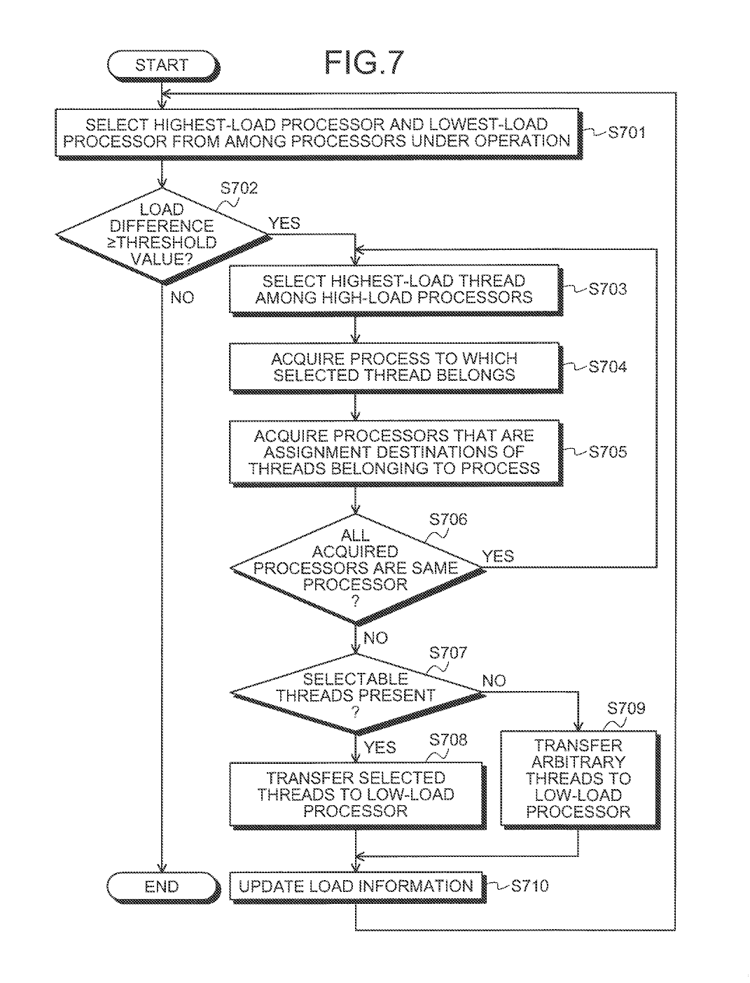

FIG. 7 is a diagram of an example of a load distribution process executed by the load distributing unit of the OS and depicts details of the operation at step S603 in FIG. 6. The load distributing unit 124 of the OS 110 selects the highest-load processor 101 and the lowest-load processor 101 based on the loads on the processors 101 monitored by the load monitoring unit 123 (step S701) and compares the difference in the load of the highest-load processor 101 and the lowest-load processor 101, to the predetermined threshold value (step S702). If the difference in load is smaller than the threshold value (step S702: NO), the load distributing unit 124 determines that the load distribution process is unnecessary and causes the process steps to come to an end.

On the other hand, if the difference in load is greater than or equal to the threshold value (step S702: YES), the load distributing unit 124 executes the following load distribution process. The load distributing unit 124 performs control such that all the threads assigned to the highest-load processor 101 are assigned to other processors 101 and the loads on the other processors 101 are equalized.

The thread managing unit 122 selects the highest-load thread among high-load processors 101 (step S703) and the process managing unit 121 acquires the process to which the selected thread belongs (step S704). The processing amounts (the loads) of the threads differ and therefore, in this case, the threads are sequentially selected in descending order of processing amount, whereby the transfer of the threads is executed.

The load monitoring unit 123 acquires the processors 101 that are assignment destinations of the threads belonging to the process acquired at step S704 (step S705) and determines whether all the processors 101 acquired at step S705 are the same processor 101 (step S706). If all the processors 101 are the same processor 101 (step S706: YES), transfer of the threads is unnecessary and therefore, the load monitoring unit 123 returns to the operation at step S703 and executes the process for other threads.

On the other hand, if the processors 101 are not all the same processor 101 (step S706: NO), the load monitoring unit 123 determines whether selectable threads are present (step S707). If selectable threads are present (step S707: YES), the load distributing unit 124 transfers the selected threads to the low-load processor 101 (step S708). In this case, the threads to be transferred are determined such that the threads each executed independently by the processors 101 are assigned with priority to the processor 101 that is to be restarted up.

On the other hand, if the load monitoring unit 123 determines that no selectable thread is present (step S707: NO), the load distributing unit 124 transfers arbitrary threads to the low-load processors 101 (step S709). After executing the operations at steps S708 and S709, the load distributing unit 124 updates the load information (step S710), returns to the operation at step S701 and continues to execute the operations at step S701 and thereafter.

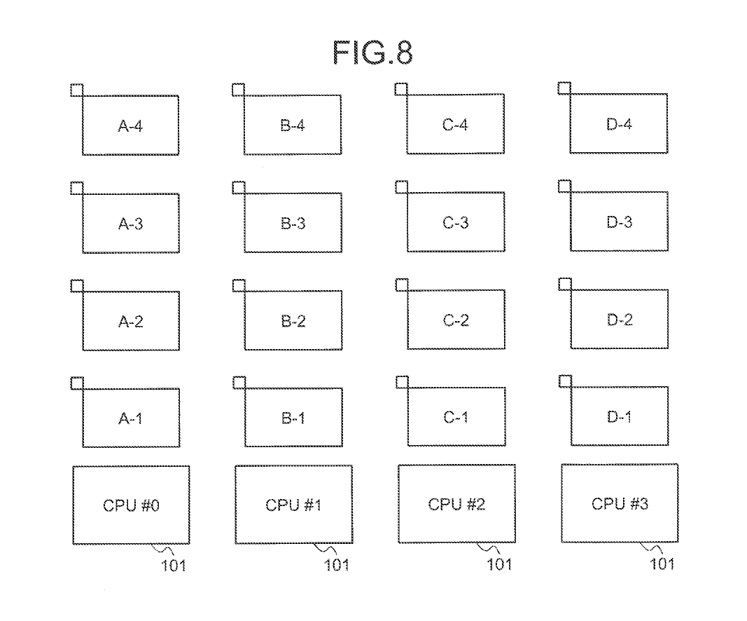

A specific example of a process of resolving the fragmentation of a process will be described with reference to FIGS. 8 to 11. FIG. 8 is a diagram of an ideal assignment state of the threads. The description will be made assuming a case as a simple example where four processors 101 start up four processes each having four threads. Assuming that the load amounts of the threads are equal, an ideal state is a state where one of the processes is assigned to one of the processors 101 as depicted in FIG. 8. In FIG. 8, “A-1” represents a first thread belonging to a process “A”, and similarly for other reference numerals. In FIG. 8, it is assumed that the four processes A, B, C, and D are present and each of the four processes A to D has the four threads 1 to 4.

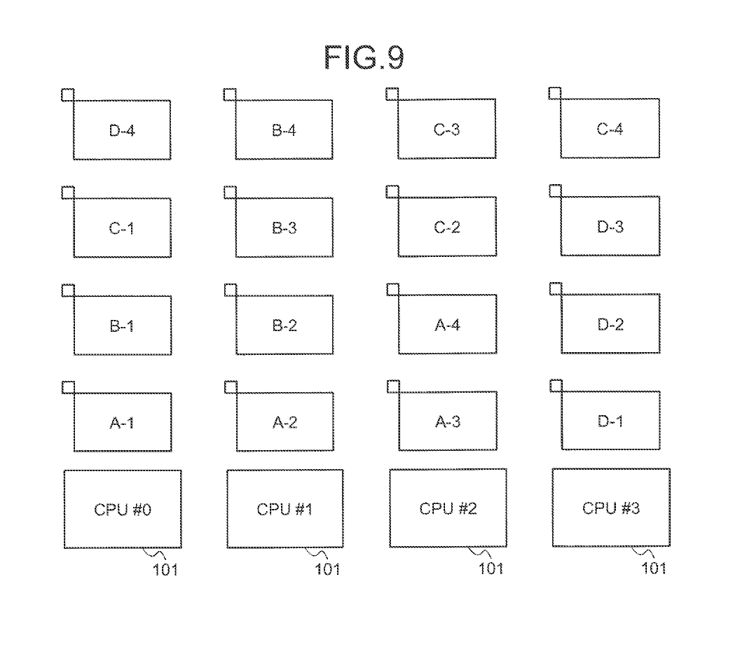

FIG. 9 is a diagram of a state where the fragmentation of the processes advances. It is assumed that, as a result of repeated starting up and suspension of the processes and threads, and consequent to the distribution of load, the threads belonging to each of the processes are distributed to different processors and are executed thereby as depicted in FIG. 9.

In the state depicted in FIG. 9, the number of operating processes is four; the number of processes assigned to the processor (CPU #0) 101 is four, including the processes A to D; the number of processes assigned to the processor (CPU #1) 101 is two, including processes the A and B; the number of processes assigned to the processor (CPU #2) 101 is two, including the processes A and C; and the number of processes assigned to the processor (CPU #3) 101 is two, including the processes C and D. The total number of assigned processes=4+2+2+2=10 and the number of operating processes=4 and therefore, the fragmentation rate in this case is 10/4=2.5. When the fragmentation rate exceeds the threshold value, the restart-up determining unit 203 of the fragmentation monitoring unit 104 outputs a restart-up request to the processor (CPU #0) 101 whose number of processes is the greatest (the number of assigned processes thereof is four).

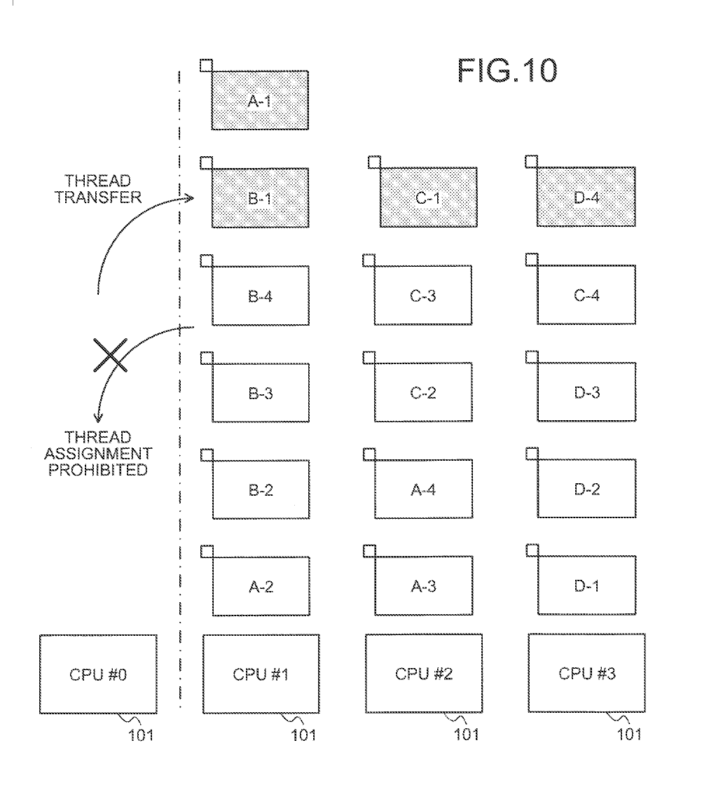

FIG. 10 is a diagram of a state of the thread transfer among the processors. The processor (a first CPU #0) 101 receives a restart-up request; issues to each of the other processors (a second group CPUs #1 to #3) 101, an instruction to prohibit thread assignment to the processor (CPU #0) 101; and transfers to the other processors (CPUs #1 to #3) 101, the threads A-1, B-1, C-1, and D-4 (the shaded threads in FIG. 10) assigned to the processor (CPU #0) 101. The transfer in this case is executed by the load distributing unit 124 of the OS 110 as above and is executed such that the loads on the processors (CPUs #1 to #3) 101 to which the threads are transferred are equalized.

In this case, the number of processors 101 to be assigned threads is reduced and therefore, the threads belonging to the same process are highly likely to be assigned to the same processor. The example depicted in FIG. 10 depicts a state where all the threads B-1 to B-4 belonging to the process B are assigned to the processor (CPU #1) 101 and all the threads D-1 to D-4 belonging to the process D are assigned to the processor (CPU #3) 101.

In the example above, the number of processes is four, including the processes A to D. However, in practice, several dozen to more than one hundred processes operate in a system even immediately after start up of the system. Therefore, even when the number of processors 101 is temporarily reduced by only one due to the restarting up, it may be expected that all the threads are assigned to the same processor.

Thereafter, the processor (CPU #0) 101 transfers all the threads assigned thereto to other processors (CPUs #1 to #3) 101, notifies the other processors (CPUs #1 to #3) 101 of the completion of the transfer of the threads, and restarts up the processor (CPU #0) 101.

After the restarting up of the processor (CPU #0) 101, for the processors (CPUs #1 to #3) 101, the load monitoring unit 123 of the OS 110 detects that no thread is assigned to the processor (CPU #0) 101 and the load on the processor (CPU #0) 101 is extremely low. Thus, the load distributing unit 124 transfers to the processor (CPU #0) 101, the threads from the high-load processor in descending order of load of the processors (CPU #1 to #3) 101 until the loads on all the processors are equalized.

In this transfer of the threads, the threads that are assigned to the high-load processor 101 and whose number is fewer than the number of threads in the process are transferred to the restarted-up processor (CPU #0) 101 with priority. It is assumed in the example that each thread itself has a specific load (in FIG. 10, the size of each thread corresponds to the load amount thereof). Therefore, in the example, the load on the processor 101 corresponds to the number of threads of the processor 101.

In FIG. 10, the high-load processor 101 having the greatest number of threads is the processor (CPU #1) 101 and one thread is transferred from this processor (CPU #1) 101 to the processor (CPU #0) 101. The processor (CPU #1) 101 is assigned four threads (B-1 to B-4) belonging to the process B and two threads (A-1 and A-2) belonging to the process A. An arbitrary one thread (for example, A-2) is transferred to the processor (CPU #0) 101, among the threads (A-1 and A-2) belonging to the process A whose threads are not completely consolidated as the process.

Thereby, the load amounts of all the processors (CPU #1 to #3) 101 are equalized (the number of threads is four for each thereof) and therefore, thereafter, the threads assigned to the processors (CPU #1 to #3) are moved one at one time to the processor (CPU #0) 101 in arbitrary order.

Thereafter, the remaining thread belonging to the process A (for example, A-1) is moved from the processor (CPU #1) 101 to the processor (CPU #0) 101. The processor (CPU #2) 101 is assigned the three threads (C-1 to C-3) belonging to the process C and two threads (A-3 and A-4) belonging to the process A and therefore, an arbitrary one thread belonging to the process A (for example, A-3) is transferred to the processor (CPU #0) 101. The processor (CPU #3) 101 is assigned four threads (D-1 to D-4) belonging to the process D and one thread (C-4) belonging to the process C. Therefore, the thread (C-4) belonging to the process C is transferred to the processor (CPU #0) 101. Thereby, the loads on all the processors (CPU #0 to #3) 101 can be equalized and the process of moving the threads comes to an end.

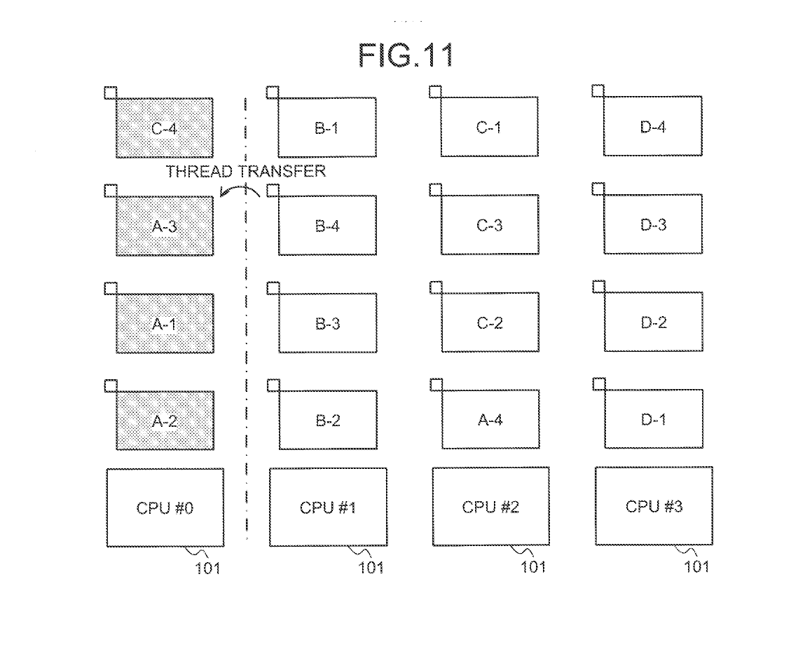

FIG. 11 is a diagram of the state where the fragmentation of the processes is improved as a result of the reassignment. After the reassignment for the processor (CPU #0) 101 comes to an end, in the example of FIG. 11, all the threads (B-1 to B-4) belonging to the process B are assigned to the same processor (CPU #1) 101 and all the threads (D-1 to D-4) belonging to the process D are assigned to the same processor (CPU #3) 101. For each of the processes A and C, the number of respective threads assigned to a single processor (CPUs #0 and #2) 101 is increased compared to the state of the fragmentation (the state of FIG. 9).

Thus, the threads executed by the processors (CPU #0 to #3) 101 are largely those belonging to the same process, enabling the processing efficiency to be improved. From the viewpoints of efficient use of the cache and reduction of the communication between the processors, even in the case where the threads belonging to the same process are not executed by the same processor 101, the effect may be expected to some extent when among all the threads, the rate of the threads assigned to the same processor 101 is high. The fragmentation rate in the state depicted in FIG. 11 is (2+1+2+1)/4=1.5 and thus, the fragmentation rate has been reduced.

As described, when the fragmentation of the processes is advanced, the threads assigned to one processor are distributed to other processors, and the number of operating processors is reduced in a pseudo manner. Thereby, it may be expected that the fragmentation is reduced. For the example above, a simple example is taken where the number of processes is four for the four processors and the number of threads is four for each of the four processes. In practice, the number of processes is significantly great compared to the number of processors and therefore, resolution of the fragmentation may be expected.

When the number of processes becomes great, it is very difficult to determine the assignment of the threads to the processors that minimizes the fragmentation while maintaining the load balance among the processors. However, according to the technique disclosed herein, assignment that takes into consideration only the load balance is normally executed and, only when the fragmentation of the processes exceeds the predetermined level, the fragmentation of the processes can be resolved by merely restarting up an arbitrary processor. As to resolving the fragmentation of the processes, the technique disclosed herein does not primarily act to minimize fragmentation but improves the state of fragmentation by the simple process. Therefore, according to the technique disclosed herein, compared to an approach of further minimizing fragmentation as the number of operating processes increases, or an approach of distributing load without taking into consideration fragmentation, fragmentation is resolved by a simple configuration that enables threads of the same process to be easily consolidated at the same processor, thereby enabling the processing efficiency of the entire system to be improved.

In general, concerning the search for all process combinations, based on relations between the number of processors and the number of processes:
1. When the number of processors is small and the number of processes is small, all process (threads) combinations can be searched for;
2. When the number of processors is small and the number of processes is great, not all the combinations can be searched for because the number of combinations explosively increases; and
3. When the number of processors is great, it is difficult to consolidate each of the processes simply because the number of processors is great.

It takes a very long time to determine the combinations for optimal assignment of the processes and threads to the processors to resolve fragmentation and equalize the load balance when the number of processes and the number of threads are great as above. In this regard, by the technique disclosed herein to a case where the number of processors is small (two to four CPUs) and the number of processes is great and thereby, the restarting up of the processor alone can consolidate the threads of a single process at a single processor, thereby enabling the processing efficiency to be improved.

According to the technique disclosed herein, the scheduling is executed as usual taking into consideration only the load balance among the processors and as usual, the overhead for the scheduling does not increase. When the fragmentation of processes is advanced, the fragmentation can be improved by the simple process of temporarily reducing the number of operating processors. As described, this simple process can improve the fragmentation of the processes and can equalize the load balance among the processors.

The multi-core processor system and the scheduling method enable processes among plural processors to be easily consolidated according to process even if the processes are fragmented.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising:
a plurality of CPUs;
memory that is shared among the CPUs; and
a monitoring unit that instructs a change of assignment of threads to the CPUs based on a first process count stored in the memory and representing a count of processes under execution by the CPUs and a second process count representing a count of processes assigned to the CPUs, respectively.

2. The multi-core processor system according to claim 1, wherein
the monitoring unit includes a comparing unit that compares a ratio of the second process count to the first process count with a predetermined threshold value.

3. The multi-core processor system according to claim 2, wherein
the monitoring unit instructs a first CPU to change the assignment of the threads when a result of comparison by the comparing unit indicates that the ratio exceeds the threshold value.

4. The multi-core processor system according to claim 1, wherein
the monitoring unit when instructing the change of the assignment of the threads to the CPUs, outputs a restart-up request to the first CPU of which the second process count is a predetermined value.

5. The multi-core processor system according to claim 1, wherein
the first process count and the second process count are stored in the memory.

6. The multi-core processor system according to claim 1, wherein
the monitoring unit sets the threshold value based on any one of or any combination of a count of the CPUs, cache size, a coherent operation time period, a time period from suspension of a CPU to restarting-up of the CPU, and a probability for a process to be consolidated.

7. The multi-core processor system according to claim 1, wherein
an operating system of the CPUs includes a load distributing unit that receives from the monitoring unit, a restart-up request for the first CPU and sequentially reassigns to the first CPU, high-load threads from high-load CPUs among the CPUs.

8. A scheduling method of a multi-core processor system that includes a plurality of CPUs, the scheduling method comprising:
instructing a second CPU group to which a first thread is assigned, that assignment of threads to a first CPU is prohibited, based on a thread reassignment instruction that is based on a ratio at which a plurality of threads included in a same process are assigned to a plurality of differing CPUs;
transferring to the second CPU group, a second thread assigned to the first CPU; and
permitting assignment of the first thread and the second thread transferred to the second CPU group, to the first CPU.

9. The scheduling method according to claim 8, further comprising
assigning to the first CPU and when the first thread and the second thread are included in a first process, a third thread included in a second process different from the first process.

10. The scheduling method according to claim 8, further comprising
assigning to the first CPU and when the first thread and the second thread are respectively included different in processes, any one among the first thread, the second thread, and a third thread.

11. The scheduling method according to claim 8, further comprising
transferring a thread from the second CPU group to the first CPU, when a difference of a load on the first CPU and a load on the second CPU group is greater than a given value determined in advance.

12. The scheduling method according to claim 8, further comprising
calculating the ratio based on a count of processes under execution by all the CPUs including the first CPU, the second CPU group, and when present, other CPUs excluding the first CPU and the second CPU group, and based on a count of the processes assigned to the first CPU, the second CPU group, and the other CPUs.
